(19) United States
(12) Patent Application Publication
(10) Pub. No.: US 2011/0148641 A1
(43) Pub. Date: Jun. 23, 2011

(54) APPARATUS FOR DETECTING SURVIVAL STATUS OF LIVING THING AND METHOD USING THE SAME

(75) Inventors: Woo-Sug Jung, Daejeon (KR); Jong-Arm Jun, Daejeon (KR); Jong-Suk Chae, Daejeon (KR); Dong-Jin Lee, Gwangyang-si (KR)

(73) Assignee: Electronics and Telecommunications Research Institute, Daejeon (KR)

(21) Appl. No.: 12/972,924

(22) Filed: Dec. 20, 2010

(30) Foreign Application Priority Data
Dec. 21, 2009 (KR) 10-2009-0128407

(51) Int. Cl. G08B 23/00

(52) U.S. Cl. 340/573.1

(57) ABSTRACT

Disclosed herein are an apparatus and method for detecting the survival status of a living thing. The apparatus for detecting the survival status of a living thing includes a tilt sensor, a determination unit, and a communication unit. The tilt sensor is attached to a target living thing, and detects minute vibrations generated by the motion of the target living thing. The determination unit determines the survival status of the target living thing for a preset update period based on the minute vibrations. The communication unit sends an update packet including determination results of the determination unit to an outside.

### CROSS REFERENCE TO RELATED APPLICATION

This application claims the benefit of Korean Patent Application No. 10-2009-0128407 filed on Dec. 21, 2009, which is hereby incorporated by reference in its entirety into this application.

### BACKGROUND OF THE INVENTION

1. Technical Field

The present invention relates generally to an apparatus and method for detecting the survival status of a living thing using a tilt sensor, and, more particularly, to technology which is capable of determining the survival status of a living thing using minute vibrations, generated by the motion of the living thing, without using complicated detection means.

2. Description of the Related Art

It is sometimes required to continuously conduct protective observation of the survival status of a subject of a biological experiment, a hospitalized patient or an old person in solitude. Although a human may observe the survival status of a subject living thing at a location beside it, it is substantially difficult to observe the survival status of all subject target living things.

Accordingly, a variety of types of technologies which are capable of monitoring the survival status of target living things by measuring the variety of types of biosignals of the living things, such as body temperature or pulsation, have been introduced.

However, the above conventional technologies have problems because complicated devices are required to continuously measure biosignals and a large amount of power is required to be consumed in order to monitor the survival status of living things by continuously operating complicated apparatuses.

Furthermore, technology that uses biosignals, such as body temperature or pulsation, has the problem of the amount of power consumed increasing even more because erroneous operation thereof may occur due to the generation of unexpected noises during an actual measuring process and, thus, signal processing, such as filtering, must be performed to prevent erroneous operation.

Commonly, apparatuses for detecting the survival status of living things frequently move alongside the target living things and must continuously monitor the survival status of the living things for long periods of time, so that they need to be small and light and to consume small amounts of power.

Therefore, there is a demand for new technology for detecting the survival status of living things, which is light, consumes a small amount of power, and can continuously monitor the survival status of a living thing for a long period of time.

### SUMMARY OF THE INVENTION

Accordingly, the present invention has been made keeping in mind the above problems occurring in the prior art, and an object of the present invention is to provide technology that can detect the survival status of a living thing using minute vibrations, generated by the activity of the living thing, without using additional complicated detection means, thus being capable of monitoring the survival status of the living thing using a small amount of power.

Another object of the present invention is to provide technology which can detect the survival status of a living thing without requiring complicated signal processing, thereby reducing the power that is wasted while the survival status of the living thing is being monitored.

Still another object of the present invention is to provide technology which is configured such that an apparatus for detecting survival status can perform part of the functionality of determining survival status and that a server side performs part of the functionality using a death count, thereby enabling the survival status of a living thing to be accurately determined by simply attaching a simple apparatus to the living thing.

In order to accomplish the above object, the present invention provides an apparatus for detecting the survival status of a living thing, including a tilt sensor attached to a target living thing and configured to detect minute vibrations generated by motion of the target living thing; a determination unit configured to determine survival status of the target living thing for a preset update period based on the minute vibrations; and a communication unit configured to send an update packet including determination results of the determination unit to an outside.

The update packet may include a survival information field indicating survival status for the update period; and a death count field indicating the number of successive update periods for which the motion of the target living thing was not detected.

The update period may be determined depending on the target living thing.

The determination unit may activate a motion detection signal indicating survival of the target living thing for the update period if the minute vibrations were detected in the update period. The tilt sensor may activate a vibration detection signal while the vibrations of the target living thing are being detected, and the determination unit may activate the motion detection signal at the edge at which the vibration detection signal is activated.

The communication unit may create the value of the survival information field using the motion detection signal.

The update packet may be sent to the outside within an update interval which is a preset interval within the update period.

The apparatus may further include a location determination unit for creating information about the location of the target living thing.

The update packet may further include a location information field indicating the information about the location.

The location determination unit may create the information about the location of the target living thing using a GPS device.

In order to accomplish the above object, the present invention provides a method of detecting survival status of a living thing, including a tilt sensor attached to a target living thing detecting minute vibrations generated by motion of the target living thing; a determination unit determining survival status of the target living thing for a preset update period based on the minute vibrations; and a communication unit sending an update packet including determination results of the determination unit to an outside.

The method may further include a location determination unit creating information about the location of the target living thing.

The update packet may be sent to the outside within an update interval which is a preset interval within the update period.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an apparatus for detecting the survival status of a living thing according to an embodiment of the present invention;

FIG. 2 is a timing diagram indicating signals which are used in the apparatus for detecting survival status, which is shown in FIG. 1;

FIG. 3 is a diagram showing an example of an update packet which is used in the apparatus for detecting survival status, which is shown in FIG. 1;

FIG. 4 is a diagram showing an example of the motion information field 321 shown in FIG. 3; and

FIG. 5 is a flowchart showing a method of detecting the survival status of a living thing according to an embodiment of the present invention.

### DESCRIPTION OF THE PREFERRED EMBODIMENTS

Reference now should be made to the drawings, in which the same reference numerals are used throughout the different drawings to designate the same or similar components.

Preferred embodiments of the present invention will be described in detail below with reference to the accompanying drawings.

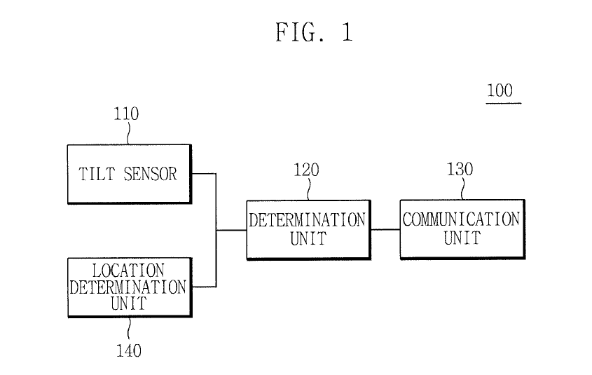

FIG. 1 is a block diagram of an apparatus for detecting the survival status of a living thing according to an embodiment of the present invention.

Referring to FIG. 1, the apparatus for detecting the survival status of a living thing according to an embodiment of the present invention includes a tilt sensor 110, a determination unit 120, a communication unit 130, and a location determination unit 140.

The tilt sensor 110 is attached to a target living thing, and detects minute vibrations generated by the motion of the target living thing.

The tilt sensor 110 may be implemented using a bar and a weight connected to the bar. In general, the tilt sensor 110 is chiefly used to measure inclination. In contrast, in the present invention, when a target living thing moves, the weight fastened to the bar on one side thereof moves, which enables minute vibrations, generated by the motion of the target living thing, to be detected.

In this case, although the apparatus for detecting the survival status of a living thing including the tilt sensor 110 may be attached to any location on the target living thing, it is preferable to attach it at the end thereof which generates relatively frequent motions.

The determination unit 120 determines the survival status of the target living thing for a preset update period based on the minute vibrations.

The determination unit 120 determines that the target living thing had been alive if minute vibrations detected by the tilt sensor 110 occurred within a predetermined time range. In this case, the determination unit 120 determines that the subject living thing was moving if vibrations were detected by the tilt sensor 110 using an edge trigger method, and also determines that the target living thing had been alive if it is determined that a motion was present within a predetermined time range.

In general, when a tile sensor is used, a signal generated by a minute external impact is considered to be noise, and is filtered out by hardware or software. However, since the present invention is configured to determine whether a living thing had been alive by detecting such a minute signal, filtering functionality is not added, but minute vibrations generated by a living thing can be detected.

That is, in the present invention, minute vibrations can be detected because the tilt sensor 110 does not filter out minute signals.

Here, the predetermined time range may be an update period which is used to provide notification of the survival status of the target living thing to the outside.

In this case, the determination unit 120 may activate a motion detection signal indicating the survival of the target living thing for the update period if minute vibrations were detected within the update period.

Here, the update period may vary according to the target living thing. For example, the update period may be set to a shorter period for a living thing that makes frequent motions, while the update period may be set to a longer period for a living thing that occasionally makes motions. Furthermore, the update period may be set depending on the importance of a living thing, such as the social status or other conditions. That is, the update period may be set to a shorter period for a living thing that has a high level of importance, while the update period may be set t a longer period for a living thing that has a low level of importance. This is one of the methods of minimizing the power consumption of a corresponding device.

That is, in the present invention, if the motion of the target living thing was detected within the update period, it may be determined that the target living thing had been alive.

Since the present invention is configured not to filter a biosignal detected from a living thing but to determine the motion of the target living thing using an edge trigger method, it is possible to detect slight motions of the living thing.

According to an embodiment, the tilt sensor 110 activates a vibration detection signal while the vibrations of the target living thing are being detected, and the determination unit 120 may activate the motion detection signal at the edge where the vibration detection signal is activated.

The communication unit 130 sends an update packet including the results of the determination of the determination unit 120 to the outside using wireless communication.

Here, the update packet may include a survival information field indicating the survival status for the update period and a death count field indicating the number of successive update periods for which the motion of the target living thing was not detected.

The results of the determination sent by the communication unit 130 to the outside are sent to a monitoring device (not shown), that is, a server side component, so that the survival status of the target living thing can be monitored.

In this case, it is preferable to use a wireless communication method as a method for communication between the communication unit 130 and the monitoring device so as to guarantee mobility. In this case, one of a variety of types of known technology may be used to carry out the wireless communication.

According to an embodiment, the communication unit 130 may create the value of the survival information field, included in the update packet, using the motion detection signal.

The location determination unit 140 creates information about the location of the target living thing.

That is, the location determination unit 140 is used to provide information about the location of the target living thing, in addition to the information about the survival status of the target living thing, so as to enable the target living thing to be monitored in greater detail.

Here, Global Positioning System (GPS) technology, which is now being widely used to determine locations, may be used as the means used by the location determination unit 140 to determine the location. However, it is not necessary that the location determination unit 140 determine the location using GPS technology, and the location may be determined by a method other than GPS technology.

When the location determination unit 140 is included, the communication unit 130 may send the location information, along with the information about survival status, to the outside.

That is, the determination unit 120 determines the survival status of the target living thing for each predetermined period. At the same time, the location determination unit 140 creates the location information for each predetermined period, and the communication unit 130 may periodically send information about the results of the determination and the location information to the outside for each predetermined period.

According to the embodiment, the update packet may be sent to the outside within an update interval which is an interval which is preset within the update period.

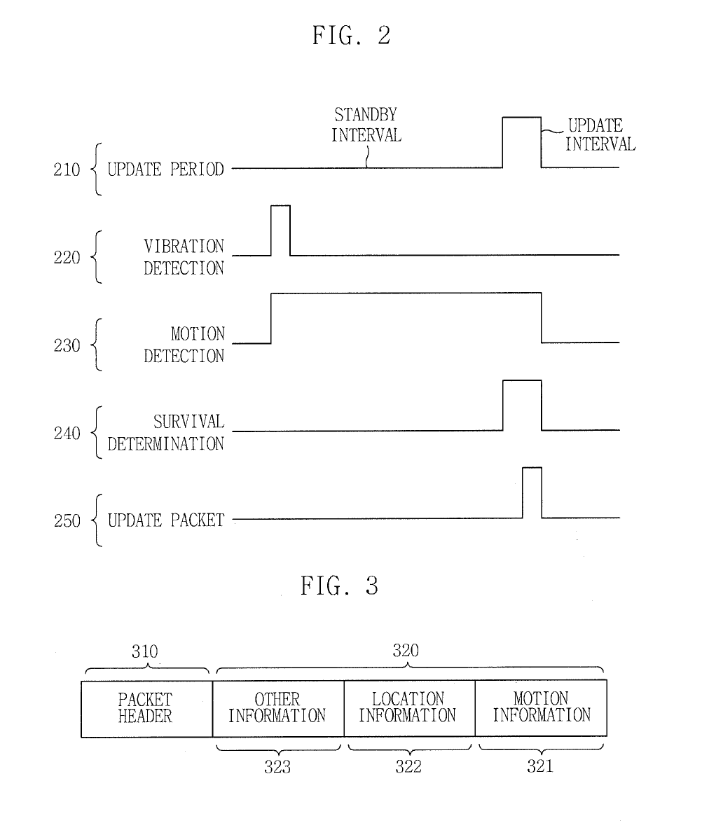

FIG. 2 is a timing diagram indicating signals which are used in the apparatus for detecting survival status shown in FIG. 1.

Referring to FIG. 2, it can be seen that the update period signal 210 is activated for a specific interval (an update interval) within each update period.

An update packet for a corresponding update period is sent in an interval for which the update period signal 210 is activated.

The vibration detection signal 220 is activated when the tile sensor detects the vibrations of the target living thing. That is, the vibration detection signal 220 can be activated only while the tile sensor is detecting minute vibrations of the target living thing.

Here, the threshold value of the minute vibrations which activate the vibration detection signal 220 may be set to a value which varies depending on the target living thing.

The motion detection signal 230 is activated at the rising edge of the vibration detection signal 220. Once the motion detection signal 230 has been activated within the update period, it may not be activated again.

The survival determination signal 240 is activated when the motion detection signal 230 is activated for an interval (an update interval) for which the update period signal 210 is activated.

The update packet 250 created by the communication unit is also created in the update interval, and is then sent to the external monitoring device.

After the update packet 250 has been sent, signals 230, 240 and 250 intended to detect the motion of the target living thing for the next update period are initialized.

Here, the update packet 250 may include location information created by the location determination unit.

FIG. 3 is a diagram showing an example of an update packet which is used in the apparatus for detecting survival status, which is shown in FIG. 1.

Referring to FIG. 3, the update packet includes a packet header 310 and a payload 320.

The packet header 310 may include control information required for data to be transmitted.

The payload 320 may include a motion information field 321, a location information field 322, and another information field 323.

The motion information field 321 includes information about the survival status of a target living thing.

The location information field 322 includes information about the location of the target living thing.

The other information field 323 includes other information related to the target living thing.

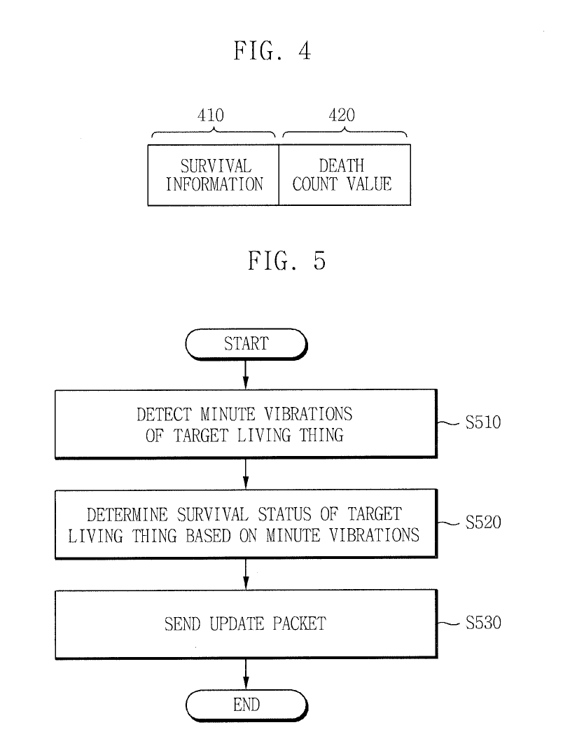

FIG. 4 is a diagram showing an example of the motion information field 321 shown in FIG. 3.

Referring to FIG. 4, the motion information field may include a survival information field 410 and a death count value 420.

The survival information field 410 indicates whether the target living thing has been alive for the update period.

For example, the survival information field 410 may be implemented using two bits. Although one bit is sufficient to enable the survival information field 410 to indicate survival information, it is preferred that two or more bits be assigned to prevent bit error because the survival information is important data.

The death count value 420 indicates the number of successive update periods for which the motion of the target living thing was not detected.

For example, the death count value 420 may be implemented using four bits.

The external monitoring device can be aware of the number of update periods for which the motion of the target living thing was not detected using the death count value 420. Depending on the type of target living thing, it is determined that a living thing is dead only if the death count is 5 or more, and it is determined that a living thing is dead only if the death count is 10 or more.

FIG. 5 is a flowchart showing a method of detecting the survival status of a living thing according to an embodiment of the present invention.

Referring to FIG. 5, the method of detecting the survival status of a living thing according to an embodiment of the present invention detects minute vibrations, generated by the motion of the target living thing, using a tilt sensor attached to the target living thing at step S510. Furthermore, the method of detecting the survival status of a living thing determines the survival status of the living thing for the preset update period based on the minute vibrations at step S520.

Here, at step S520, if the minute vibrations were detected in the update period, a motion detection signal indicating the survival of the target living thing for the update period may be activated.

Furthermore, the method of detecting the survival status of a living thing sends an update packet including the determination results of the determination unit to the outside at step S530.

Here, the update packet may include a survival status field indicating the survival status for the update period and a death count field indicating the number of successive update periods for which the motion of the target living thing was not detected. In this case, the update packet may be sent to the outside within an update interval which is a preset interval within the update period.

Here, at step S530, the value of the survival information field may be created using the motion detection signal.

The method of detecting the survival status of a living thing, which is shown in FIG. 5, may further include the step of creating information about the location of the target living thing using GPS technology or the like. Here, the update packet may further include a location information field indicating the information about the location.

As described above, the present invention provides technology that can detect the survival status of a living thing using minute vibrations, generated by the activity of the living thing, without using additional complicated detection means, thus being capable of monitoring the survival status of the living thing using a small amount of power.

Furthermore, the present invention provides technology which can detect the survival status of a living thing without requiring complicated signal processing, thereby reducing the power that is wasted while the survival status of the living thing is being monitored.

Moreover, the present invention provides technology which is configured such that an apparatus for detecting survival status can perform part of the functionality of determining survival status and that a server side performs part of the functionality using a death count, thereby enabling the survival status of a living thing to be accurately determined by simply attaching a simple apparatus to the living thing.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for detecting survival status of a living thing, comprising:
a tilt sensor attached to a target living thing and configured to detect minute vibrations generated by motion of the target living thing;
a determination unit configured to determine survival status of the target living thing for a preset update period based on the minute vibrations; and
a communication unit configured to send an update packet including determination results of the determination unit to an outside.

2. The apparatus as set forth in claim 1, wherein the update packet comprises:
a survival information field indicating survival status for the update period; and
a death count field indicating the number of successive update periods for which the motion of the target living thing was not detected.

3. The apparatus as set forth in claim 2, wherein the update period is determined depending on the target living thing.

4. The apparatus as set forth in claim 2, wherein the determination unit activates a motion detection signal indicating survival of the target living thing for the update period if the minute vibrations were detected in the update period.

5. The apparatus as set forth in claim 4, wherein the tilt sensor activates a vibration detection signal while the vibrations of the target living thing are being detected, and the determination unit activates the motion detection signal at an edge at which the vibration detection signal is activated.

6. The apparatus as set forth in claim 4, wherein the communication unit creates a value of the survival information field using the motion detection signal.

7. The apparatus as set forth in claim 2, wherein the update packet is sent to the outside within an update interval which is a preset interval within the update period.

8. The apparatus as set forth in claim 2, further comprising a location determination unit to for creating information about a location of the target living thing.

9. The apparatus as set forth in claim 8, wherein the update packet further comprises a location information field indicating the information about the location.

10. The apparatus as set forth in claim 9, wherein the location determination unit creates the information about the location of the target living thing using a Global Positioning System (GPS) device.

11. A method of detecting survival status of a living thing, comprising:
detecting, by a tilt sensor attached to a target living thing, minute vibrations generated by motion of the target living thing;
determining survival status of the target living thing for a preset update period based on the minute vibrations; and
sending an update packet including determination results of the determination unit to an outside.

12. The method as set forth in claim 11, wherein the update packet comprises:
a survival information field indicating survival status for the update period; and
a death count field indicating the number of successive update periods for which the motion of the target living thing was not detected.

13. The method as set forth in claim 12, wherein the determining survival status of the target living thing comprises activating a motion detection signal indicating survival of the target living thing for the update period if the minute vibrations were detected in the update period.

14. The method as set forth in claim 13, wherein the sending the update packet including determination results of the determination unit to an outside comprises creating a value of the survival information field using the motion detection signal.

15. The method as set forth in claim 14, wherein the update packet is sent to the outside within an update interval which is a preset interval within the update period.

16. The method as set forth in claim 12, further comprising creating information about a location of the target living thing.

17. The method as set forth in claim 16, wherein the update packet further comprises a location information field indicating the information about the location.
